(19) United States
(12) Patent Application Publication
(10) Pub. No.: US 2025/0335125 A1
(43) Pub. Date: Oct. 30, 2025

(54) MEMORY CONTROLLER, MEMORY SYSTEM AND OPERATING METHOD

(71) Applicant: YANGTZE MEMORY TECHNOLOGIES CO., LTD., Wuhan (CN)

(72) Inventor: Mo CHENG, Wuhan (CN)

(21) Appl. No.: 18/912,213

(22) Filed: Oct. 10, 2024

(30) Foreign Application Priority Data
Apr. 29, 2024 (CN) 202410534429.2

(51) Int. Cl. G06F 3/06

(52) U.S. Cl. CPC G06F 3/0659; G06F 3/0604; G06F 3/0656; G06F 3/0679

(57) ABSTRACT

Examples of the present disclosure disclose a memory controller, a memory system and an operating method thereof, the memory controller includes a processor and a data buffer; the processor is configured to: control a memory device to sequentially write data into a buffer area of the memory device; and sequentially write the data in the buffer area into the storage area of the memory device; wherein the buffer area includes multiple first zones which include contiguous physical addresses and equal storage capacities, the first zone includes multiple first memory cells in which data is stored in a single-level mode; the storage area includes multiple second memory cells in which data is stored in a multi-level mode.

### CROSS-REFERENCE TO RELATED APPLICATIONS

This application claims priority to and the benefit of Chinese Patent Application No. 202410534429.2, filed on Apr. 29, 2024, which is hereby incorporated herein by reference in its entirety.

### TECHNICAL FIELD

Examples of the present disclosure relate to the field of semiconductor technology, and more particularly to a memory controller, a memory system and an operating method thereof.

### BACKGROUND

A memory device is a storage device for preserving information in modern information technology. Some semiconductor memories, including some nonvolatile memories and volatile memories, have gradually become a mainstream product in the storage market due to its high storage density, controllable production cost, suitable programming and erasing speed and retention characteristics.

### SUMMARY

According to some aspects of the examples of the present disclosure, a memory controller is provided, the memory controller includes a processor and a data buffer; the processor is configured to: control a memory device to sequentially write data into a buffer area of the memory device; and sequentially write the data in the buffer area into the storage area of the memory device; wherein the buffer area includes multiple first zones which include contiguous physical addresses and equal storage capacities, the first zone includes multiple first memory cells in which data is stored in a single-level mode; the storage area includes multiple second memory cells in which data is stored in a multi-level mode.

In some examples, the processor is further configured to: configure multiple memory cells of the memory device as the buffer area and the storage area.

In some examples, the storage area includes multiple second zones which include contiguous physical addresses and equal storage capacities; the storage capacity of each of the second zones is equal to the storage capacity of each of the first zones; the processor is further configured to: control the memory device to sequentially write data in the first zone into the second zone; and erase data in the first zone that has been written into the second zone.

In some examples, the processor is further configured to: in response to the amount of data to be written to the memory device being less than or equal to the storage capacity of the buffer area, control the memory device to write data into the buffer area; and control the memory device to write data in one first zone into one second zone, the written addresses in the second zone being contiguous.

In some examples, the processor is further configured to: in response to the amount of data to be written to the memory device being greater than the storage capacity of the buffer area, write a portion of data into the buffer area; control the memory device to sequentially write data in the first zone into the second zone, and erase the first zone; wherein one first zone corresponds to one second zone; and control the memory device to write another portion of data into the erased first zone.

In some examples, the processor is further configured to: generate a mapping table, the mapping table including a space number and flag information; wherein one second zone corresponds to one space number, and the number of space numbers is equal to the number of second zones; one space number corresponds to one first zone; the flag information includes first information and second information; the first information indicates that the first zone is stored with data, and the second information indicates that the second zone is stored with data.

In some examples, the first zone includes multiple first subzones which include equal storage capacities and contiguous physical addresses, and the number of memory cells in the first subzone is equal to the number of memory cells in the second zone; a first one of first subzones in the first zones corresponds to one space number.

In some examples, the processor is further configured to: calculate the space number corresponding to the logical address according to a logical address corresponding to the data to be read; obtain the physical address corresponding to the logical address from the mapping table according to the space number and the flag information; and control the memory device to read the data corresponding to the physical address.

In some examples, the data buffer is configured to store the mapping table.

In some examples, the data buffer is configured to: store data which is to be written into the buffer area; the processor is further configured to: write the data into the buffer area.

According to some aspects of an example of the present disclosure, a memory system is provided, wherein the memory system includes: a memory controller configured to send the first operation command; and a memory device coupled to the memory controller; the memory device includes: a buffer area and a storage area; wherein the buffer area includes multiple first zones which include contiguous physical addresses and equal storage capacities, the first zone includes multiple first memory cells in which data is stored in a single-level mode; the storage area includes multiple second memory cells in which data is stored in a multi-level mode; the memory device is configured to: in response to the first operation command, sequentially write data into the buffer area; and sequentially write data in the buffer area into the storage area.

In some examples, the memory controller is further configured to: configuring multiple memory cells of the memory device as the buffer area and the storage area.

In some examples, the storage area includes multiple second zones which include contiguous physical addresses and equal storage capacity; the storage capacity of each of the second zones is equal to the storage capacity of each of the first zones; the memory device is further configured to: sequentially write data in the first zone into the second zone; and erase the data in the first zone that has been written into the second zone.

In some examples, the memory device is further configured to: in response to the amount of data to be written to the memory device being less than or equal to the storage capacity of the buffer area, write data into the buffer area; and write data in one first zone into one second zone, the written addresses in the second zone being contiguous.

In some examples, the memory device is configured to: in response to the amount of data to be written to the memory device being greater than the storage capacity of the buffer area, write a portion of data into the buffer area; sequentially write data in the first zone into the second zone, and erase the first zone; wherein one first zone corresponds to one second zone; and write another portion of data into the erased first zone.

In some examples, the memory controller is further configured to: generate a mapping table, the mapping table including a space number and flag information; wherein one second zone corresponds to one space number, and the number of space numbers is equal to the number of second zones; one space number corresponds to one first zone; the flag information includes first information and second information; the first information indicates that the first zone is stored with data, and the second information indicates that the second zone is stored with data.

In some examples, the first zone includes multiple first subzones which include equal storage capacities and contiguous physical addresses, and the number of memory cells in the first subzone is equal to the number of memory cells in the second zone; a first one of first subzones in the first zones corresponds to one space number.

In some examples, the memory controller is further configured to: calculate the space number corresponding to the logical address according to the logical address corresponding to the data to be read; obtain the physical address corresponding to the logical address from the mapping table according to the space number and the flag information; and send the second operation command; the memory device is configured to read data corresponding to the physical address in response to the second operation command.

According to some aspects of the examples of the present disclosure, an electronic system is provided, including: a host and a memory system; the memory system including a memory device and a memory controller coupled to the memory device; in response to a first operation request from the host, the memory controller is configured to: control the memory device to sequentially write data into a buffer area of the memory device; and sequentially write the data in the buffer area into the storage area of the memory device; wherein the buffer area includes multiple first zones which include contiguous physical addresses and equal storage capacities, the first zone includes multiple first memory cells in which data is stored in a single-level mode; the storage area includes multiple second memory cells in which data is stored in a multi-level mode.

In some examples, the memory controller is configured to: in response to the first operation request, configure the multiple memory cells of the memory device as the buffer area and the storage area.

In some examples, the storage area includes multiple second zones which include contiguous physical addresses and equal storage capacities; the storage capacity of each of the second zones is equal to the storage capacity of each of the first zones; the memory controller is further configured to: control the memory device to sequentially write data in the first zone into the second zone; and erase the data in the first zone that has been written into the second zone.

In some examples, the memory controller is further configured to: in response to the amount of data to be written to the memory device being less than or equal to the storage capacity of the buffer area, control the memory device to write data into the buffer area; and control the memory device to write data in one first zone into one second zone, the written addresses in the second zone being contiguous.

In some examples, the memory controller is further configured to: in response to the amount of data to be written to the memory device being greater than the storage capacity of the buffer area, writing a portion of data into the buffer area; control the memory device to sequentially write data in the first zone into the second zone, and erase the first zone; wherein one first zone corresponds to one second zone; and write another portion of data into the erased first zone.

In some examples, the memory controller is further configured to: generate a mapping table, the mapping table including a space number and flag information; wherein one second zone corresponds to one space number, and the number of space numbers is equal to the number of second zones; one space number corresponds to one first zone; the flag information includes first information and second information; the first information indicates that the first zone is stored with data, and the second information indicates that the second zone is stored with data.

In some examples, the first zone includes multiple first subzones which include equal storage capacities and contiguous physical addresses, and the number of memory cells in the first subzone is equal to the number of memory cells in the second zone; a first one of first subzones in the first zones corresponds to one space number.

In some examples, the memory controller is configured to: in response to a second operation request from the host, calculate the space number corresponding to the logical address according to the logical address corresponding to the data to be read; obtain the physical address corresponding to the logical address from the mapping table according to the space number and the flag information; and control the memory device to read the data corresponding to the physical address.

According to some aspects of the examples of the present disclosure, a method for controlling a memory controller is provided, including: controlling a memory device to sequentially write data into a buffer area of the memory device; and sequentially write the data in the buffer area into the storage area of the memory device; wherein the buffer area includes multiple first zones which include contiguous physical addresses and equal storage capacities, the first zone includes multiple first memory cells in which data is stored in a single-level mode; the storage area includes multiple second memory cells in which data is stored in a multi-level mode.

In some examples, the method further includes: configuring multiple memory cells of the memory device as the buffer area and the storage area.

In some examples, the storage area includes multiple second zones which include contiguous physical addresses and equal storage capacities; the storage capacity of each of the second zones is equal to the storage capacity of each of the first zones; the method further includes: controlling the memory device to sequentially write data in the first zone into the second zone; and erasing data in the first zone that has been written into the second zone.

In some examples, the method further includes: in response to the amount of data to be written to the memory device being less than or equal to the storage capacity of the buffer area, controlling the memory device to write data into the buffer area; controlling the memory device to write data in one first zone into one second zone, the written addresses in the second zone being contiguous.

In some examples, the method further includes: in response to the amount of data to be written to the memory device being greater than the storage capacity of the buffer area, writing a portion of data into the buffer area; controlling the memory device to sequentially write data in the first zone into the second zone, and erase the first zone; wherein one first zone corresponds to one second zone; writing another portion of data into the erased first zone.

In some examples, the method further includes: generating a mapping table, the mapping table including a space number and flag information; wherein one second zone corresponds to one space number, and the number of space numbers is equal to the number of second zones; one space number corresponds to one first zone; the flag information includes first information and second information; the first information indicates that the first zone is stored with data, and the second information indicates that the second zone is stored with data.

In some examples, the first zone includes multiple first subzones which include equal storage capacities and contiguous physical addresses, and the number of memory cells in the first subzone is equal to the number of memory cells in the second zone; a first one of first subzones in the first zones corresponds to one space number.

In some examples, the method further includes: calculating the space number corresponding to the logical address according to the logical address corresponding to the data to be read; obtaining the physical address corresponding to the logical address from the mapping table according to the space number and the flag information; and controlling the memory device to read the data corresponding to the physical address.

According to some aspects of an example of the present disclosure, a method for operating a memory system is provided, including:
sending, by a memory controller, a first operation command; in response to the first operation command, sequentially writing data into a buffer area of a memory device; and
sequentially writing the data in the buffer area into the storage area of the memory device; wherein the buffer area includes multiple first zones which include contiguous physical addresses and equal storage capacities, the first zone includes multiple first memory cells in which data is stored in a single-level mode; the storage area includes multiple second memory cells in which data is stored in a multi-level mode.

In some examples, the method further includes: configuring multiple memory cells of the memory device as the buffer area and the storage area.

In some examples, the storage area includes multiple second zones which include contiguous physical addresses and equal storage capacities; the storage capacity of each of the second zones is equal to the storage capacity of each of the first zones; the method further includes: sequentially writing data in the first zone into the second zone; and erasing the data in the first zone that has been written into the second zone.

In some examples, the method further includes: in response to the amount of data to be written to the memory device being less than or equal to the storage capacity of the buffer area, writing data into the buffer area; and writing data in one first zone into one second zone, the written addresses in the second zone being contiguous.

In some examples, the method further includes: in response to the amount of data to be written to the memory device being greater than the storage capacity of the buffer area, writing a portion of data into the buffer area; sequentially writing data in the first zone into the second zone, and erasing the first zone; wherein one first zone corresponds to one second zone; writing another portion of data into the erased first zone.

In some examples, the method further includes: generating a mapping table, the mapping table including a space number and flag information; wherein one second zone corresponds to one space number, and the number of space numbers is equal to the number of second zones; one space number corresponds to one first zone; the flag information includes first information and second information; the first information indicates that the first zone is stored with data, and the second information indicates that the second zone is stored with data.

In some examples, the first zone includes multiple first subzones which include equal storage capacities and contiguous physical addresses, and the number of memory cells in the first subzone is equal to the number of memory cells in the second zone; a first one of first subzones in the first zones corresponds to one space number.

In some examples, the method further includes: calculating the space number corresponding to the logical address according to the logical address corresponding to the data to be read; obtaining the physical address corresponding to the logical address from the mapping table according to the space number and the flag information; sending, by the memory controller, a second operation command, and reading, by the memory device, data corresponding to the physical address in response to the second operation command.

According to some aspects of an example of the present disclosure a readable storage medium is further provided, the readable storage medium having a computer program stored thereon, that when executed, may implement any one of the methods described above.

### BRIEF DESCRIPTION OF THE DRAWINGS

FIG. 1 is a schematic diagram of an example system shown according to an example of the present disclosure;

FIG. 2a is a schematic diagram of an example memory card shown according to an example of the present disclosure;

FIG. 2b is a schematic diagram of an example solid state drive shown according to an example of the present disclosure;

FIG. 3 is a schematic diagram of an example memory device according to an example of the present disclosure;

FIG. 4 is an example schematic cross-sectional view of a memory cell array shown according to an example of the present disclosure;

FIG. 5 is a schematic diagram of another example memory device shown according to an example of the present disclosure;

FIG. 6 is a schematic diagram of an example memory system shown according to an example of the present disclosure;

FIG. 7 is a schematic diagram of another example memory device according to an example of the present disclosure;

FIGS. 8 to 13 are schematic diagrams of example mapping tables shown according to an example of the present disclosure;

FIG. 14 is a schematic diagram of a method for controlling an example memory controller according to an example of the present disclosure;

FIG. 15 is a schematic diagram of a method for operating an example memory controller according to an example of the present disclosure.

### DETAILED DESCRIPTION

Example examples of the present disclosure will be described in more detail below with reference to the accompanying drawings. Although example implementations of the present disclosure are shown in the accompanying drawings, it should be understood that the present disclosure may be implemented in various forms and should not be limited to the specific implementations set forth herein. Rather, these examples are provided so that the present disclosure can be more thoroughly understood and the scope of the present disclosure can be fully conveyed to those skilled in the art.

In the following description, numerous specific details are given in order to provide a more thorough understanding of the present disclosure. However, it will be apparent to one skilled in the art that the present disclosure may be practiced without one or more of these details. In other examples, in order to avoid confusion with the present disclosure, some technical features known in the art are not described; that is, not all features of the actual example are described here, and well-known functions and structures are not described in detail.

It will be understood that, although the terms first, second, third etc., may be used to describe various elements, components, regions, layers and/or parts, these elements, components, regions, layers and/or parts should not be limited by these terms. These terms are only used to distinguish one element, component, region, layer or part from another element, component, region, layer or part. Thus, a first element, component, region, layer or part discussed below may be termed as a second element, component, region, layer or part without departing from teachings of the present disclosure. Whereas a second element, component, region, layer or part is discussed, it does not indicate that a first element, component, region, layer or part necessarily presents in the present disclosure.

A term used herein is for the purpose of describing a particular example only and is not to be considered as limitation of the present disclosure. As used herein, the singular forms “a”, “an” and “said/the” are intended to include the plural forms as well, unless the context clearly dictates otherwise. It should also be understood that the terms “consists of” and/or “comprising”, when used in this description, identify the presence of stated features, integers, steps, operations, elements and/or parts, but do not exclude the presence or addition of one or more other features, integers, steps, operations, elements, parts and/or groups. As used herein, the term “and/or” includes any and all combinations of the associated listed items.

It should be understood that reference throughout the description to “some examples” or “an example” means that a particular feature, structure or characteristic related to the example is included in at least one example of the present disclosure. Thus, appearances of “in some examples” or “in an example” in various places throughout the description are not necessarily referring to a same example. Furthermore, these particular features, structures or characteristics may be combined in any appropriate manner in one or more examples. It should be understood that in various examples of the present disclosure, sequence numbers of the processes described above do not mean the execution order, and the execution order of each process should be determined by its function and internal logic, and should not constitute any limitation to implementation process of examples of the present disclosure.

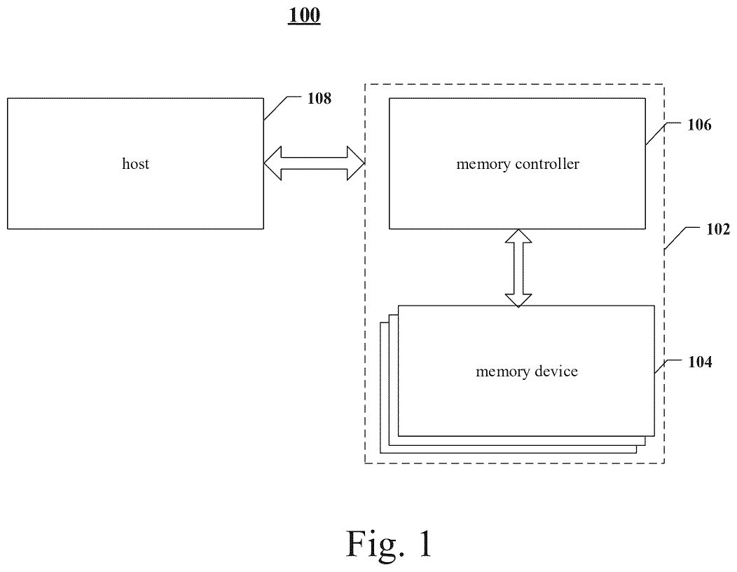

FIG. 1 illustrates a block diagram of an example system 100 with memory devices in accordance with some aspects of the present disclosure. The system 100 may be an electronic system 100, which may include but is not limited to a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having memory device therein. As shown in in FIG. 1, system 100 may include a host 108 and a memory system 102, and the memory system 102 has one or more memory devices 104 and a memory controller 106. The host 108 may be a processor of an electronic device (e.g., a central processing unit (CPU)) or a system on chip (SoC) (e.g., an application processor (AP)). Host 108 may be configured to send data to or receive data from memory device 104. The memory device 104 may include, but is not limited to memory such as 2D or 3D NAND (Not-And) type memory, or NOR type memory, ferroelectric random access memory (FRAM), magnetic random access memory (MRAM), Phase-Change Memory (PCM), Resistive Random Access Memory (RRAM), etc.

According to some implementations, memory controller 106 is coupled to memory device 104 and host 108 and is configured to control memory device 104. Memory controller 106 may manage data stored in memory device 104 and communicate with host 108. In some implementations, memory controller 106 is designed to operate in low duty cycle environments, e.g., Secure Digital (SD) card, Compact Flash (CF) card, Universal Serial Bus (USB) flash drive, or other media for use in electronic devices such as personal computer, digital camera, mobile phone, etc. In some implementations, the memory controller 106 is designed to operate in high duty cycle environments such as SSD or embedded multimedia card (eMMC), where SSDs or eMMCs are used as data storage for mobile devices such as smartphone, tablet computer, laptop computer, and enterprise storage array.

Memory controller 106 may be configured to control operations of memory device 104, e.g., read, erase and program operations. Memory controller 106 may also be configured to manage various functions related to data stored or to be stored in memory device 104, including but not limited to bad block management, garbage collection, logical-to-physical address translation, wear leveling, etc. In some implementations, memory controller 106 is also configured to process error correction code (ECC) related to data read from or written to memory device 104. The memory controller 106 may also perform any other suitable functions, e.g., formatting the memory device 104. Memory controller 106 may communicate with external devices (e.g., host 108) according to a particular communication protocol. For example, the memory controller 106 may communicate with an external device through at least one of various interface protocols, e.g., USB protocol, MMC protocol, Peripheral Component Interconnect (PCI) protocol, PCI Express (PCI-E) protocol, advanced Technology Attachment (ATA) protocol, Serial ATA protocol, Parallel ATA protocol, Small Computer Small Interface (SCSI) protocol, Enhanced Small Disk Interface (ESDI) protocol, Integrated Drive Electronics (IDE) protocol, Firewire protocol, etc.

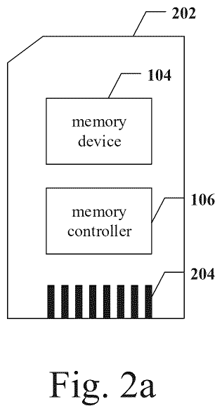

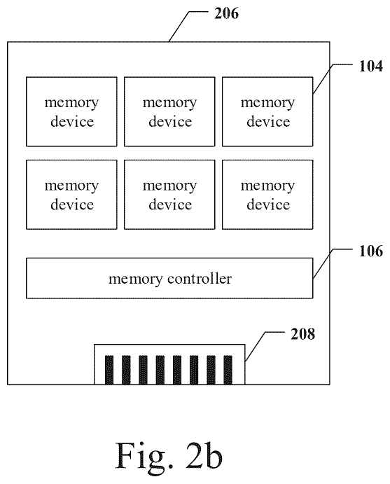

Memory controller 106 and one or more memory devices 104 may be integrated into various types of storage devices, e.g., included in the same package (e.g., Universal Flash Storage (UFS) package or eMMC package). That is, memory system 102 may be implemented and packaged into different types of end electronic products. In one example as shown in FIG. 2a, memory controller 106 and a single memory device 104 may be integrated into a memory card 202. Memory card 202 may include a PC card (PCMCIA, personal computer memory card international association), a CF card, a smart media (SM) card, a memory stick, a multimedia card (MMC, RS-MMC, MMCmicro), an SD card (SD, miniSD, microSD, SDHC), a UFS, etc. Memory card 202 may further include a memory card connector 24 coupling memory card 202 with a host (e.g., host 108 in FIG. 1). In another example as shown in FIG. 2b, memory controller 20 and multiple memory devices may be integrated into SSD 206. SSD 206 may further include an SSD connector 208 coupling the SSD 206 with a host (e.g., host 108 in FIG. 1). In some implementations, at least one of the storage capacity or operating speed of SSD 206 is greater than at least one of the storage capacity or operating speed of memory card 202.

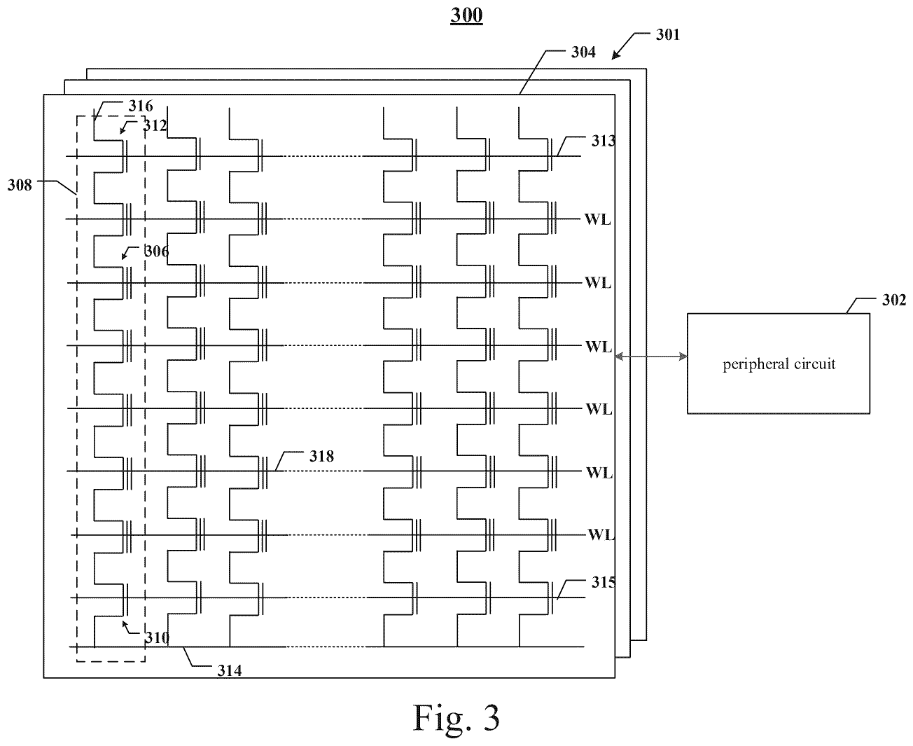

The memory device 104 in the example of the present disclosure is explained by taking a NAND (Not-And) memory as an example, and the memory device 104 in the example of the present disclosure may include other memories. FIG. 3 illustrates a schematic circuit diagram of an example memory device 300 including peripheral circuitry according to some aspects of the present disclosure. Memory device 300 may be an example of memory device 104 in FIG. 1. The memory device 300 may include a memory cell array 301 and a peripheral circuit 302 coupled to the memory cell array 301. Taking memory cell array 301 being a three-dimensional NAND memory cell array as an example for illustration, where memory cells 306 are provided in an array of NAND memory strings 308, each NAND memory string extending vertically over a substrate (not shown). In some implementations, each NAND memory string 308 includes multiple memory cells 306 coupled in series and stacked vertically. Each memory cell 306 may retain a contiguous analog value, e.g., voltage or charge, depending on the number of electrons trapped within the area of the memory cell 306. Each memory cell 306 may be a “floating gate” type memory cell including a floating gate transistor, or a “charge trap” type memory cell including a charge trap transistor.

In some implementations, each memory cell 306 is a single-level cell (SLC) that has two possible memory states and may thus store one bit of data. For example, a first memory state of “0” may correspond to a first voltage range, and a second memory state of “1” may correspond to a second voltage range. In some implementations, each memory cell 306 is a multi-level cell (MLC) capable of storing more than a single bit of data in more than four memory states. For example, MLCs can store two bits per cell, three bits per cell (also known as triple-level cells (TLC)), or four bits per cell (also known as quad-level cells (QLC)). Each MLC can be programmed to assume a range of possible nominal storage values. In an example, if each MLC stores two bits of data, the MLC may be programmed to write one of three possible nominal storage values into the cell, a fourth nominal storage value other than these three possible nominal storage values may be to represent an erase state.

As shown in FIG. 3, each NAND memory string 308 may include a lower selection gate (BSG) 310 at its source terminal and a upper selection gate (TSG) 312 at its drain terminal. BSG 310 and TSG 312 may be configured to activate a selected NAND memory string 308 during read and program operations. In some implementations, the sources of NAND memory strings 308 in a same memory block 304 are coupled through a same source line (SL) 314 (e.g., a common SL). In other words, according to some implementations, all NAND memory strings 308 in a same memory block 304 have an array common source (ACS). According to some implementations, TSG 312 of each NAND memory string 308 is coupled to a corresponding bit line (BL) 316 from which data may be read or written via an output bus (not shown). In some implementations, each NAND memory string 308 is configured to be selected or deselected through at least one of applying a select voltage (e.g., above the threshold voltage of a transistor with a TSG 312) or a deselect voltage (e.g., OV) to the corresponding TSG 312 via one or more TSG lines 313 or applying a select voltage (e.g., above the threshold voltage of a transistor with a BSG 310) or a deselect voltage (e.g., OV) to the corresponding BSG 310 via one or more BSG lines 315.

As also shown in FIG. 3, NAND memory string 308 may be organized into multiple memory blocks 304 each of which may have a common source line 314 (e.g., coupled to ground). In some implementations, each memory block 304 is the basic data unit for an erase operation, i.e., all memory cells 306 on the same memory block 304 are erased simultaneously. To erase the memory cell 306 in the selected memory block, source line 314 coupled to selected memory block and to unselected memory blocks in the same plane as selected memory block may be biased with an erase voltage (Vers) (e.g., a high positive voltage (e.g., 20V or higher)). It should be understood that, in some examples, erase operations may be performed at the half-memory block level, at the quarter-memory block level, or at a level with any suitable number of memory blocks or any suitable fraction of memory blocks. Memory cells 306 of adjacent NAND memory strings 308 may be coupled through a word line 318 that selects which row of memory cells 306 is affected by read and program operations.

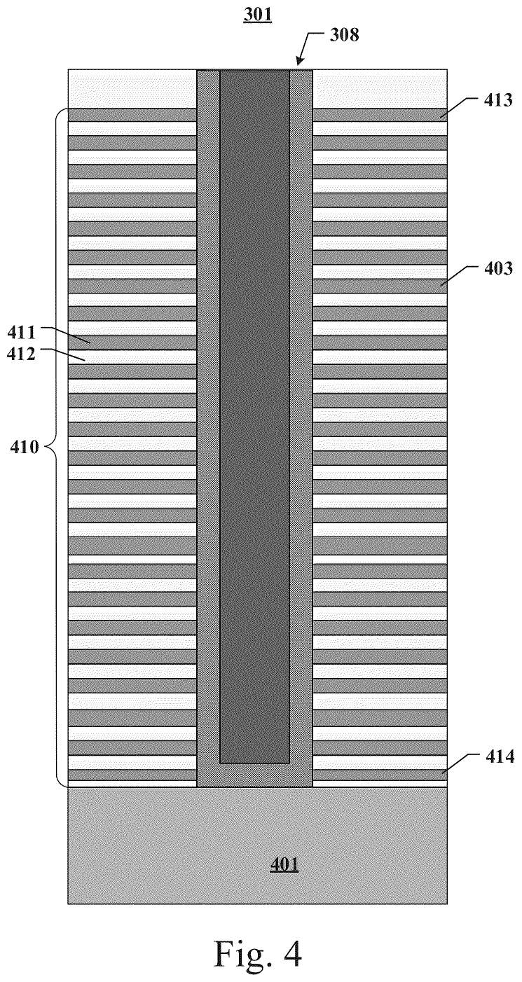

FIG. 4 illustrates a schematic cross-sectional view of an example memory cell array 301 including NAND memory strings 308 according to some aspects of the present disclosure. As shown in FIG. 4, the NAND memory string 308 may include a stacked structure 410, the stacked structure 410 includes multiple gate layers 411 and multiple insulating layers 412 alternately stacked in sequence, and memory string 308 vertically penetrating through gate layers 411 and insulating layers 412. Gate layers 411 and the insulating layers 412 may be stacked alternately, and two adjacent gate layers 411 are separated by an insulating layer 412. The number of pairs of gate layer 411 and insulating layer 412 in the stacked structure 410 may determine the number of memory cells included in the memory cell array 301.

A constituent material of the gate layer 411 may include a conductive material. Conductive materials include, but are not limited to, tungsten (W), cobalt (Co), copper (Cu), aluminum (Al), polysilicon, doped silicon, silicide, or any combination thereof. In some examples, each gate layer 411 includes a metal layer, e.g., a tungsten layer. In some examples, each gate layer 411 includes a doped polysilicon layer. Each gate layer 411 may include a control gate surrounding a memory cell. A gate layer 411 at the top of a stacked structure 410 may extend laterally as an upper selection gate line, a gate layer 411 at the bottom of a stacked structure 410 may extend laterally as a lower selection gate line, and a gate layer 411 extending laterally between a upper selection gate line and a lower selection gate line may serve as a word line layer.

In some examples, a stacked structure 410 may be disposed on a substrate 401. The substrate 401 may include silicon (e.g., monocrystalline silicon), silicon germanium (SiGe), gallium arsenide (GaAs), germanium (Ge), silicon-on-insulator (SOI), germanium-on-insulator (GOI), or any other appropriate material.

In some examples, NAND memory string 308 includes a channel structure extending vertically through stacked structure 410. In some implementations, a channel structure includes a channel hole filled with semiconductor material(s) (e.g., as a semiconductor channel) and dielectric material(s) (e.g., as a memory film). In some implementations, a semiconductor channel includes silicon, e.g., polysilicon. In some implementations, a memory film is a composite dielectric layer including a tunneling layer, a storage layer (also referred to as a “charge trapping/storage layer”), and a blocking layer. A channel structure may have a cylindrical shape (e.g., a pillar shape). According to some implementations, a semiconductor channel, a tunneling layer, a storage layer and a blocking layer are radially arranged in this order from the center of the pillar toward the outer surface of the pillar. A tunneling layer may include silicon oxide, silicon oxynitride, or any combination thereof. A storage layer may include silicon nitride, silicon oxynitride, or any combination thereof. A barrier layer may include silicon oxide, silicon oxynitride, a high-k (high-k) dielectric, or any combination thereof. In an example, a memory film may include a composite layer of silicon oxide/silicon oxynitride/silicon oxide (ONO).

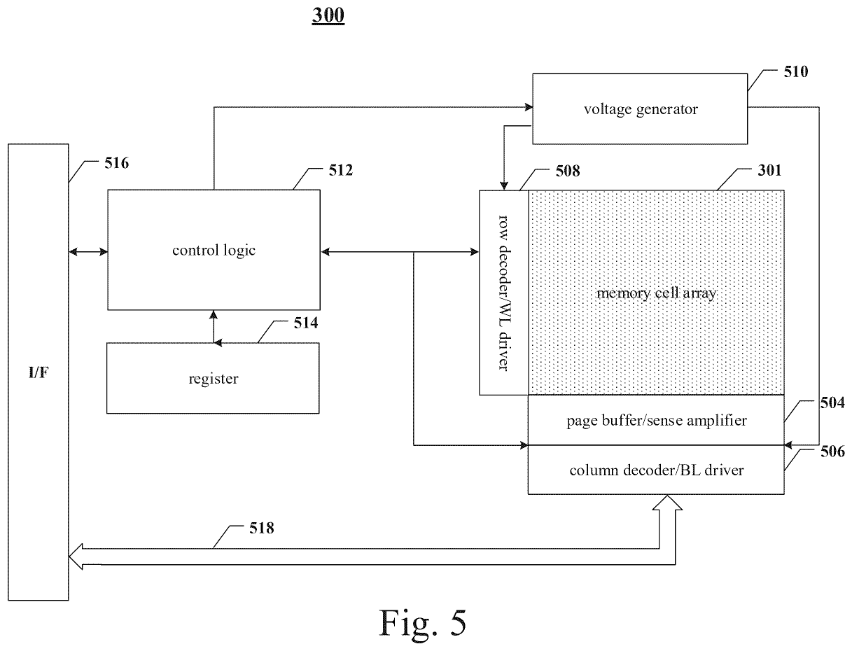

Referring back to FIG. 3, the peripheral circuit 302 may be coupled to the memory cell array 301 through bit line 316, word line 318, source line 314, BSG line 315, and TSG line 313. The peripheral circuit 302 may include any suitable analog, digital, and mixed-signal circuitry for facilitating operation of the memory cell array 301 through at least one of applying at least one of a voltage signal or a current signal to and sense voltage signal or current signal from each target memory cell 306 via bit line 316, word line 318, source line 314, BSG line 315, and TSG line 313. The peripheral circuit 302 may include various types of peripheral circuits formed with metal-oxide-semiconductor (MOS) technology. For example, FIG. 5 illustrates some example peripheral circuits, peripheral circuit 302 includes page buffer/sense amplifier 504, column decoder/bit line driver 506, row decoder/word line driver 508, voltage generator 510, control logic 512, register 514, interface 516 and data bus 518. It should be understood that in some examples, additional peripheral circuits not shown in FIG. 5 may also be included.

The page buffer/sense amplifier 504 may be configured to read data from and program (write) data to the memory cell array 301 according to control signals from the control logic 512. In one example, the page buffer/sense amplifier 504 may store programming data (written data) to be programmed into the memory cell array 301. In another example, page buffer/sense amplifier 504 may perform a programming verify operation to ensure that data has been correctly programmed into memory cell 306 coupled to selected word line 318. In yet another example, page buffer/sense amplifier 504 may also sense a low power signal from bit line 316 representing a data bit stored in memory cell 306 and amplify a small voltage swing to a recognizable logic level during a read operation. The column decoder/bit line driver 506 may be configured to be controlled by control logic 512 and to select one or more NAND memory strings 308 through applying a bit line voltage generated from voltage generator 510.

The row decoder/word line driver 508 may be configured to be controlled by control logic 512 and select/deselect memory block 304 of memory cell array 301 and select/deselect word line 318 of memory block 304. The row decoder/word line driver 508 may also be configured to drive word line 318 with a word line voltage generated from voltage generator 510. In some implementations, the row decoder/word line driver 508 may also select/deselect and drive the BSG line 315 and the TSG line 313. As described in detail below, the row decoder/word line driver 508 is configured to perform program operations on the memory cells 306 coupled to the selected word line 318. The voltage generator 510 may be configured to be controlled by the control logic 512, and generate word line voltage (e.g., read voltage, programming voltage, pass voltage, channel boost voltage, verify voltage, etc.), bit line voltage and source line voltage to be supplied to the memory cell array 301.

The control logic 512 may be coupled to each of the peripheral circuits described above and configured to control operations of each of the peripheral circuits. The register 514 may be coupled to the control logic 512 and include state register, command register and address register for storing state information, command operation code (OP code) and command address for controlling operations of each of the peripheral circuits. The interface 516 may be coupled to control logic 512 and act as a control buffer to buffer and relay control commands received from a host (not shown) to control logic 512 and to buffer and relay state information received from the control logic 512 to the host. Interface 516 may also be coupled to column decoder/bit line driver 506 via data bus 518 and act as a data I/O interface and data buffer to buffer and relay data to/from memory cell array 301.

In some examples, according to storage density, the memory cell of the NAND memory may be divided into single-layer memory cell (one-bit memory cell), double-layer memory cell (two-bit memory cell), triple-layer memory cell (three-bit memory cell), quad-layer memory cell (four-bit memory cell), and five-layer memory cell (five-bit memory cell), however, no matter the single-layer memory cell or the multi-layer memory cell, the read operation thereof may be performed in units of pages. In some examples, when a read operation is being performed, a read voltage is applied to the word line coupled to the selected page in the memory device 104 (i.e., the selected word line), and when the read voltage reaches the threshold voltage of multiple memory cells coupled to the selected word line, or the number of memory cells that have not reached the threshold voltage is within an allowable range, the read operation of the entire page is completed. The memory cell may be an M-bit memory cell, and the memory cell has 2^{M} data states including an erase state, and the M-bit storage data is read through a 2^{M}-1-level read voltage. In some examples, e.g., the first-level read voltage is between the threshold voltages of the erase state and the first data state, and when the first-level read voltage is applied to the word line, the memory cell in the erase state is turned on, and the memory cell in the first data state is not turned on, the erase state and the first data state are distinguished and read out.

It should be noted that during the read operation, a memory cell that has not reached the target threshold voltage are labeled as an error bit, and in order to prevent read errors, error correction code (ECC) is introduced, when the number of error bits is less than or equal to the maximum number of failed bits that can be corrected by the error correction code, all error bits in the read operation can be corrected, so that correct reading of data can be achieved.

In some examples, the host 108 sends a read command (or a read instruction, a read request) to the memory controller 106 according to the current user command requirement; the memory controller 106 transmits the read control command including the logical address-physical address mapping table and other information to the memory device 104 through the interface 516, and controls the memory device 104 to perform a read operation on the memory cell corresponding to the corresponding physical address; the memory device 104 sends the read data to the memory controller 106 via the interface 516; and the memory controller 106 feeds the data back to the host 108 via an interface such as PCIe or SATA. In some examples, the memory controller 106 sends the read control command to the control logic of the memory device via the interface 516, and the control logic applies the relevant operate voltage to the selected word line or bit line according to the relevant physical address, thereby performing a read operation on the corresponding memory cell. The operate voltage may be generated by the control logic according to the relevant read voltage mapping table to control the voltage generator to generate the relevant operate voltage, and then applied to the word line of the corresponding address through the row decoder, or applied to the bit line of the corresponding address through the column decoder.

In some examples, when the memory device 104 reads the corresponding memory cell under the control of the memory controller 106, a read error occurs, at this point, the memory controller 106 (or the error correction module in the memory controller 106) controls the memory device 104 to perform error correction in response to the failure of the read operation, the error correction mode may include ECC error correction.

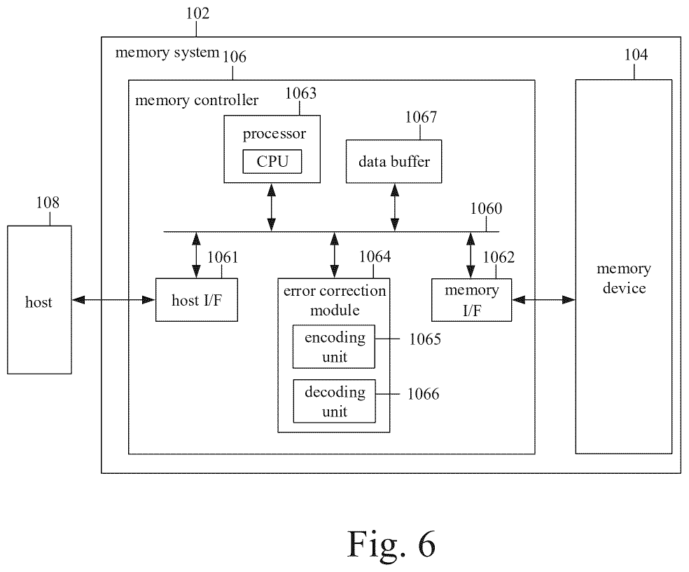

FIG. 6 provides a block diagram of a memory controller 106 for the memory system 102. Referring to FIG. 6, the memory system 102 includes a memory controller 106 and a memory device 104, the memory controller 106 and memory device 104 may be coupled in any suitable manner. In the disclosed example, the memory controller 106 includes a host I/F 1061, a memory I/F 1062, a processor 1063, an error correction (ECC) module 1064, a data buffer 1067, and an internal bus 1060, wherein the error correction module 1064 includes an encoding unit 1065 and a decoding unit 1066. The host I/F 1061 outputs a command, user data (write data), etc., received from the host 108 to the internal bus 1060, and sends user data (read data) read from the memory device 104, a response from the processor 1063, etc., to the host 108. The memory controller 106 may also include a ROM and a RAM, wherein the ROM stores the firmware or firmware program code of the memory controller 106, the code is to initialize and operate the various components of the memory controller 106, and the RAM is to buffer data. The ROM and the RAM interact with the processor 1063 through the internal bus 1060.

The memory I/F 1062 controls the process of writing user data, etc., to the memory device 104 and the process of reading from the memory device 104 based on the instructions of the processor 1063. The processor 1063 controls the memory system 102 as a whole, the processor 1063 is, e.g., a central processing unit (CPU), a microprocessor (MPU), etc. When the processor 1063 receives a command from the host 108 via the host I/F 1061, it performs control according to the command. For example, the processor 1063 instructs the memory I/F 1062 to write user data and parity check to the memory device 104 according to the command from the host 108. In addition, the processor 1063 instructs the memory device 104 to perform a program operation on the memory cell according to the command from the host 108 to the memory I/F 1062, and the memory device 104, after completing the program operation, updates the physical address-logical address mapping table and feeds it back to the data buffer 1067 for storage through the memory I/F 1062; alternatively, the processor 1063, according to a command from the host 108, instructs the memory device 104 to read the user data and parity check from the memory device 104. In response to the operation requirements, the control unit 103 may access the DRAM of the memory system 102 to obtain the logical address-physical address mapping table, and control, according to the address information, the memory device 104 to operate the memory cell at the relevant address; for operations such as data erase or data write, the control unit 103 will also update the logical address-physical address mapping table, or the mapping table update operation is performed by the memory device 104. For a memory system 102 without DRAM, the control unit 103 may borrow the memory of the host 108 to store the mapping table, access the host memory to obtain the mapping table, or update the mapping table; alternatively, the mapping table is a two-level mapping, the first-level mapping table is stored in the data buffer 1067 or the RAM of the memory controller 106; the second-level mapping table is stored in the memory device 104, the second-level mapping table is divided into multiple Regions, and the first-level mapping table stores the physical address in the zone in the memory device 104.

The error correction module 1064 includes an encoding unit 1065 and a decoding unit 1066, the encoding unit 1065 may encode user data of a predetermined size written into a same page to generate parity check data, and may encode based on program data to generate parity check data. The parity check data is written into the page where the user data that becomes the basis of the encoding has been written, and the decoding unit 1066 uses the parity check data for decoding. The data buffer 1067 temporarily saves the user data received from the host 108 before storing it in the memory device 104, and temporarily saves the data read from the memory device 104 before sending it to the host 108.

In some examples, for some memory systems 102 adapted to protocols such as NVMe and UFS, at least portion of the area of its memory device 104 may be defined or configured to adopt a zoned namespace, the present disclosure may define the portion of the area as a zone area, and the zone area may be divided into multiple zones, e.g., a zone0, a zone1, a zone2 . . . etc. The storage capacity of each zone is equal, the physical addresses in each zone are contiguous, the physical addresses of the zone area composed of all zones may be contiguous or discontiguous, and the definition, division, and size of the zone may be divided by the memory controller 106 according to the actual capacity and physical addresses of the memory device 104. For example, one zone may include all memory cells coupled to a word line, or one zone may include a portion of memory cells coupled to a word line, and a program operation may be performed on the portion of the memory cells separately; alternatively, one zone may include memory cells coupled to multiple word lines, e.g., one zone may be a memory block or multiple memory blocks, or a portion of a memory block. Taking the adjacent zone1 and zone2 as an example, the physical addresses of zone1 may be contiguous or discontiguous with the physical addresses of zone2, e.g., the last physical address in the zone1 may be adjacent to or not adjacent to the first physical address in the zone2; or, the first physical address in the zone1 may be adjacent to or not adjacent to the last physical address in the zone2. For example, the zone1 may be the k-th memory block, the zone2 may be the (k+1)-th or (k−1)-th memory block, and the zone2 may be other memory blocks.

The write to the zone area is a sequential writing, and the reading of the zone area may be a contiguous reading or random reading. The logical addresses corresponding to each zone are contiguous, and the logical addresses corresponding to the data stored in each zone are equal in size, and there will be no overlapping logical addresses between zones. For example, assuming that the size of each zone is the amount of data corresponding to the storage of x logical addresses, the starting logical address corresponding to the zone3 may be LBA_k˜LBA_(k+x−1). For example, the zone0 may be to store data corresponding to logical addresses LBA_1 to LBA_2000, the zone1 may be to store data corresponding to LBA_2001 to LBA_4000, the zone2 may be to store data corresponding to LBA_4001 to LBA_6000, the zone3 may be to store data corresponding to LBA_6001 to LBA_8000, . . . , etc. In addition, the data amount corresponding to a logical address may be determined by the host 108, e.g., the data amount corresponding to a logical address may be 4 kilobytes (KB). The physical storage amount of a zone is generally greater than or equal to the data amount corresponding to the maximum number of logical addresses to be written, if the zone is not fully written with the data written this time, additional data or invalid data may be written into the remaining space of a zone to maintain the storage stability of the zone data. For example, if only data corresponding to LBA_1˜LBA_1900 is written into the zone0, the remaining storage space corresponding to LBA_1901˜LBA_2000 or more storage space will be written with additional data to fill the zone0.

In some examples, after the data is sequentially written into the zone, the logical address-physical address mapping table may be updated, and the physical address may include the number information and address information of the zone; since the logical addresses are written sequentially into the zone, only a certain mapping between a certain one of logical addresses corresponding to the written data and a physical address may be recorded, and the physical addresses corresponding to other logical addresses may be calculated. Taking a zone of zones that store data corresponding to x logical addresses as an example, the logical addresses corresponding to this type of zone may be LBA_k˜LBA_(k+x−1), the physical address corresponding to the first logical address LBA_k may be recorded, and the physical address may include a zone, a memory block within the zone, a physical storage page, or even a memory cell at the intersection of a word line and a bit line; the data corresponding to other logical addresses are stored sequentially in the zone, and the physical addresses are calculated in sequence, e.g., the physical address corresponding to LBA_k+1 is a physical address which is adjacent or next to the physical address corresponding to LBA_k. For example, if a zone corresponds to a memory block, multiple memory cells coupled on a word line in the memory block constitute a physical page, a logical address may correspond to one physical page, the data corresponding to LBA_k is stored in the i-th physical page, and the data corresponding to LBA_k+1 is stored in the (i+1)-th physical page; if a logical address corresponds to n physical pages (n is a positive integer), the data corresponding to LBA_k may be stored in the i-th to (i+n−1)-th physical pages; the data corresponding to LBA_k+1 may be stored in the (i+n)-th to (i+2n−1)-th physical pages, and the physical addresses corresponding to other logical addresses are calculated similarly. The calculation of the physical address may be performed by the memory controller 106, and the memory device 104 reads data according to the physical address and feeds it back to the memory controller 106. Thus, the amount of data in the logical address-physical address mapping table may be reduced, the OP space of the memory device 104 may be saved, and more space may be saved for the memory device 104 to store user data. The OP space may be configured by the memory controller 106 for purposes such as garbage collection, wear leveling, firmware and mapping table storage, and spare data blocks.

In some examples, the present disclosure provides a memory system 102, the memory device 104 is set with a zone, and the memory device 104 may include a buffer area and a storage area, the user data to be written is first written into the buffer area, and then the data in the buffer area is written into the storage area, the buffer area has a faster operation rate than that of the storage area. Since the setting of the zone may save OP space to increase the user space for storing user data, the larger user space may facilitate the setting of a larger buffer area to increase the data writing rate, and the reduction of the data amount of the logical address-physical address mapping table facilitates reducing the write amplification of the memory device 104. For example, for some memory devices 104 of UFS protocol that include the zones and set buffer areas, the write amplification may be controlled to 1˜2, which is a significant improvement compared to the write amplification 4 of the general memory device 104 of UFS protocol, and more data may be written, and the write rate is greater. Write amplification (WA) means that the amount of physical data actually written by the memory device 104 is multiple times the amount of user data to be written.

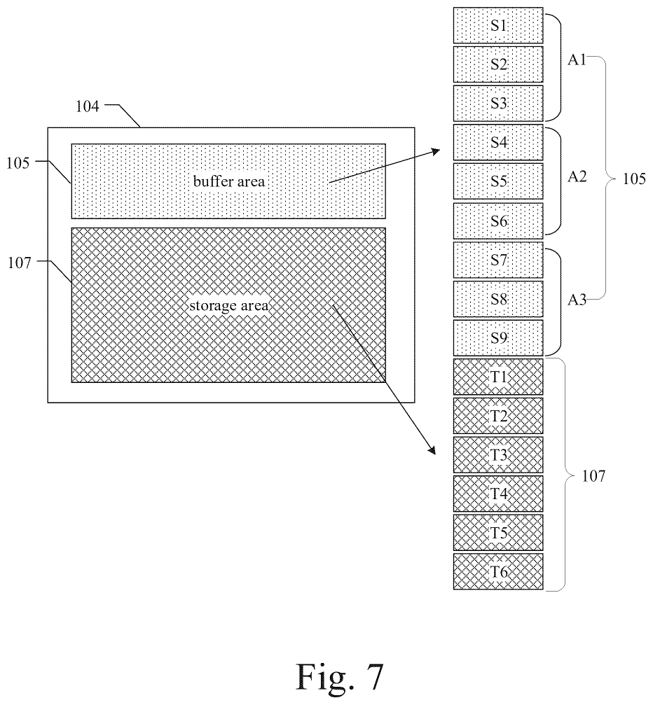

According to some aspects of the examples of the present disclosure, FIGS. 1 and 6 show a memory controller 106, the memory controller includes a processor 1063 and a data buffer 1067; the processor 1063 is configured to: control a memory device 104 to sequentially write data into a buffer area 105 of the memory device 104; and sequentially write the data in the buffer area 105 into the storage area 107 of the memory device 104; wherein the buffer area 105 includes multiple first zones which include contiguous physical addresses and equal storage capacities, the first zone includes multiple first memory cells (single level cell SLC) in which data is stored in a single-level mode; the storage area 107 includes multiple second memory cells (multiple level cell, e.g., TLC) in which data is stored in a multi-level mode. The memory device 104, the buffer area 105 and the storage area 107 may be shown in FIG. 7, the buffer area 105 may include the first zones A1˜A3, including the first subzones S1˜S9, or more; the storage area may include the second zones T1˜T6, or more.

In some examples, the processor 1063 is also configured to: configure multiple memory cells of the memory device 104 as the buffer area 105 and the storage area 107.

The buffer area 105 has a faster operation rate than that of other non-buffer areas (e.g., the storage area 107), e.g., a faster program (write) rate, the data is first programmed and written into the buffer area 105, and then written into other non-buffer areas after the buffer area 105 is fully written, and the relevant data in the buffer area 105 is erased after the data is written into the non-buffer area to release the buffer space for the next write. When the data to be written into the memory device 104 is small and the space in the buffer area 105 is sufficient for writing, the memory device 104 may migrate the data when it is idle to reduce the resource usage of the interface between the memory controller 106 and the host 108; when the data to be written into the memory device 104 is large and the space in the buffer area 105 is insufficient for writing, the memory device 104 may perform data migration in real time without waiting for the memory device 104 to enter an idle state, when the buffer is fully written, the data is migrated to the non-buffer area, there may be multiple migrations, and finally the remaining data is migrated to the non-buffer area when the memory device 104 is idle, the amount of data migrated to the non-buffer area during idle time is less than or equal to the capacity of the buffer area 105. Taking a NAND memory as an example, the buffer area 105 may include multiple first memory cells in which data is stored in a single-level mode, e.g., SLC; the non-buffer area may include multiple second memory cells in which data is stored in a multi-level mode, e.g., a two-level memory cell MLC, a three-level memory cell TLC, a four-level memory cell QLC, or a five-level memory cell PLC; compared with other memory cells, SLC has only two storage states, an erase state and a program state, and has a faster write (program) rate and read rate.

In some examples, the memory controller 106 may control the memory device 104 to perform the above-mentioned bad block management, garbage collection, and wear leveling without instructing by the host 108, so as to maintain the operation rate and reliability of the memory device 104, which may be controlled by the processor 1063. In some examples, the memory controller 106 controls the memory device 104 to perform data transfers within the memory device 104, such as bad block management, garbage collection, wear leveling without any access request by the host 108. At this point, the memory device 104 does not need to provide the memory controller 106 with data required by the host 108, nor does it need to write data from the host 108 into the memory cell array, in the example, the memory device 104 may be defined as being in an idle state at this point. After the memory device 104 performs bad block management and wear leveling, the physical-logical mapping table is updated and sent to the memory controller 106. In contrast, when data is required to be read from the memory device 104 by the host 108, or an erase operation or program operation is to be performed on the memory device 104 at present, the memory device 104 is in an activated state. In this example, the processor 1063 may control the memory device 104 to write the data in the buffer area 105 into the storage area 107 during the phase of garbage collection. at this point, the data in the buffer area 105 may be read first, and the data in the buffer area 105 that has been written into the storage area 107 may be erased after the data is written into the storage area 107.

In some examples, during the manufacturing process of the memory cell array of the memory device 104, all of its memory cells may be manufactured as multi-level memory cells, and then the multi-level memory cells may be configured as SLC. In some examples, the memory cell array is all TLC before the buffer SLC is configured, and some of storage states of the TLC may be merged to form SLC with two storage states to configure the buffer area 105. The capacity of the buffer area 105 may be fixed, that is, it is configured when the memory is shipped from the factory, which can be 0-30% of the total capacity (in some examples, 20%), or it may be dynamically divided by the processor 1063 according to the amount of data currently required to be written and the remaining capacity of the memory device 104. For example, when the capacity of the memory device 104 is large enough, the memory controller 106 divides a portion of the non-buffer area into the buffer area 105, and the capacity of the buffer area 105 at this point is sufficient to store the data sent by the host 108; and when the capacity of the memory device 104 is small, the memory device 104 cannot be divided into enough storage areas to store the data sent by the host 108, at this point, 0-30% (in some examples, 20%) of the remaining capacity of the memory device 104 may be divided into the buffer area 105. The division ratio of the storage area 107 in the example of the present disclosure is only an example, and the example of the present disclosure is not limited thereto.

In some examples, the processor 1063 may access the data buffer 1067 or the RAM memory device of the memory controller 106 to obtain the logical address-physical address mapping table, and obtain the physical addresses of the memory cells that have not been written with data according to the address mapping table, and divide a portion of the memory cells into a buffer area 105 and configure it as a first memory cell (SLC), and configure the other portion of memory cells as a second memory cell, and may feedback information or feedback a command to the memory device 104 after the division is completed, the memory device 104, after receiving the feedback information, loads the program parameters of the SLC into the corresponding registers; alternatively, no feedback information is sent, and a write command (e.g., a first operation command) is subsequently sent, the memory device 104 receives and responds to the write command, performs a program operation corresponding to the SLC on the memory cells in the buffer area 105, and performs a program operation such as the TLC on the memory cells in the storage area 107. The program operation may include an Increment Step Pulse Program (ISPP) operation, which gradually applies a programming voltage for programming and applies a verification voltage for verification to verify whether the memory cell is programmed to a target threshold value; if the target threshold is not reached, the memory cell is further programmed with a higher program voltage; the memory cell that continues to be programmed is then verified, and the above program and verification process are repeated until it is found in the verification process that the threshold voltage of the memory cell has reached the target threshold.

In some examples, as shown in FIG. 7, the buffer area 105 may include multiple first zones, taking three first zones as an example, namely first zones A1 to A3, the first zone is composed of multiple SLC memory cells, and each first zone may include multiple subzones, e.g., three first subzones; the physical addresses of each first zone are contiguous, and the physical addresses of the buffer area 105 formed by all the first zones are contiguous or discontiguous. In some examples, the last physical address in the first subzone S1 is adjacent to the first physical address in the first subzone S2, and the last physical address in the first subzone S2 is adjacent to the first physical address in the first subzone S3, the last physical address in the first subzone S3 is adjacent to or not adjacent to the first physical address in the first subzone S4, and other first subzones are not described in detail. The first zone may be the zone as described above, which may store data corresponding to contiguous logical addresses LBA_k˜LBA_(k+x−1), the amount of data stored in each zone is equal, and the corresponding logical addresses are contiguous, e.g., the first zone A1 stores data corresponding to LBA_1 to LBA_2000, the first zone A2 stores data corresponding to LBA_2001 to LBA_4000, . . . , etc. After the user data is sequentially written into the first zone, the processor 1063 generates or updates the logical address-physical address mapping table, since it is sequentially written, only a portion of the logical address-physical address mapping table may be recorded, and the other portion of the address mapping table may be calculated, thereby reducing the amount of data in the address mapping table. When the buffer area 105 is written fully or needs to be cleared to provide buffer space for the next write operation request, the data in the buffer area 105 is sequentially written into the storage area 107, and the logical address-physical address mapping table is updated, the physical address at this point is the physical address in the storage area 107.

In some examples, referring to FIG. 7, the storage area 107 includes multiple second zones which include contiguous physical addresses and equal storage capacities; the storage capacity of each of the second zones is equal to the storage capacity of each of the first zones; the processor 1063 is further configured to: control the memory device 104 to sequentially write data in the first zone into the second zone; and erase the data in the first zone that has been written into the second zone.

Taking six second zones T1˜T6 in FIG. 7 as an example, and there may be more second zones, the storage capacity of all second zones is greater than or equal to the storage capacity of the buffer area 105, the physical addresses in each second zone are contiguous, and the physical addresses in the storage area 107 composed of all second zones are contiguous or discontiguous, and the second zone includes multiple second memory cells, such as TLC. In some examples, all physical addresses of the second zone T1 are contiguous, all physical addresses of the second zone T2 are contiguous, and the last physical address in the second zone T1 is adjacent to or not adjacent to the first physical address in the second zone T2.

In some examples, the second memory cell in the second zone may be an M-level memory cell, where M is a natural number greater than 1, and the first memory cell in the first zone may be an SLC, and the number of first memory cells in the first zone is M times the number of second memory cells in the second zone; if the first zone includes a first subzone, the number of first subzones may be M, and the number of first memory cells included in each first subzone is equal to the number of second memory cells in the second zone. In some examples, the second memory cell in the second zone T1 may be a three-level memory cell TLC, and the first memory cell may be configured as SLC from TLC when the processor 1063 divides the buffer area 105, the first zone A1 may include three first subzones S1˜S3, and the number of first memory cells in the first subzone S1 is equal to the number of second memory cells in the second zone T1. As another example, if the second memory cell in the second zone is QLC, the number of first subzones in the first zone is 4, and the number of QLCs in the second zone is equal to the number of SLCs in the first subzone. For example, the first subzone may be a first memory block, and the second zone may be a second memory block, the number of memory cells in the first memory block is equal to the number of memory cells in the second memory block, the first memory block is configured as SLC, and the second memory block is configured as TLC.

In some examples, the data in the first zone is sequentially written into the second zone, and the data in the first zone A1 may be written into the second zone T1, i.e., sequentially written into the second zone T1; or the data in the first zone A1 may be written into the second zone T2, i.e., sequentially written into the second zone T2. In some examples, the data in the first zone A1 is sequentially written into the second zone T1, the data in the first zone A2 is sequentially written into the second zone T2, and the data in the first zone A3 is sequentially written into the second zone T3; e.g., the data corresponding to the logical addresses LBA_1˜LBA_2000 in the first zone A1 is written into the second zone T1, the data corresponding to LBA_2001˜LBA_4000 in the first zone A2 is written into the second zone T2, and the mapping table between the logical address and the physical address in the second zone is updated. In some other examples, if the second zone T1 is fully written before data migration, the writing may start from the next second zone T2, at this point, the data in the first zone A1 is sequentially written into the second zone T2, and the data in the first zone A2 is written into the second zone T3, etc. When the data in a certain first zone is written into the corresponding second zone, the data of the original first zone is erased.

In some examples, the processor 1063 is further configured to: in response to the amount of data to be written to the memory device 104 being less than or equal to the storage capacity of the buffer area 105, control the memory device 104 to write data into the buffer area 105; and control the memory device 104 to write data in one first zone into one second zone, the written addresses in the second zone being contiguous.

In response to a write command from the host 108, the amount of user data to be written is less than or equal to the storage capacity of the buffer area 105, when data is written into the buffer area 105 and then migrated from the buffer area 105 to the storage area 107, one first zone May correspond to one second zone, after the data in the first zone A1 is sequentially written into the second zone T1, the data in the first zone A2 is sequentially written into the second zone T2, and the data in the first zone A3 is sequentially written into the second zone T3, there is no need for erasing the buffer area 105 immediately. The operation of migrating data to the storage area 107 may be performed in real time, or a garbage collection operation may be triggered to be performed when the memory system 102 is idle.

In some examples, the processor 1063 is further configured to: in response to the amount of data to be written to the memory device 104 being greater than the storage capacity of the buffer area 105, write a portion of data into the buffer area 105; control the memory device 104 to sequentially write data in the first zone into the second zone, and erase the first zone; wherein one first zone corresponds to one second zone; and control the memory device 104 to write another portion of data into the erased first zone.

In response to a write command from the host 108, the amount of user data to be written is greater than the storage capacity of the buffer area 105, the user data at this time may not be written into the buffer area 105 at one time, thus, a portion of the data is first written into the buffer area 105, and after the data is migrated to the storage area 107, the buffer area 105 is erased and another portion of the data is written into the buffer area 105. For example, the first write may write the buffer area 105 fully, write the data in the first zone A1 into the second zone T1 in sequence, and erase the first zone A1; write the data in the first zone A2 into the second zone T2 in sequence, and erase the first zone A2; write the data in the first zone A3 into the second zone T3 in sequence, and erase the first zone A3; for the next data migration, the data in the first zone A1 is migrated to the second zone T4, the data in the first zone A2 is migrated to the second zone T5, and the data in the first zone A3 is migrated to the second zone T6, etc.

In some examples, after the buffer area 105 is fully written, the data written next time is only required to occupy space of a part of the buffer area 105, at this point, a portion of the data of the buffer area 105 may be migrated to the second zone to release part of the buffer space. If the first zones A1˜A3 are all fully written, at this point, a first zone is needed to complete the writing of the remaining data, and the data in the first zone A1 may be migrated to the second zone T1 in time and the first zone A1 may be erased, and the data migration of other first zones may be performed in the subsequent stage, thereby improving the response rate of the memory system 102.

In some examples, the processor 1063 is further configured to: generate a mapping table, the mapping table including a space number and flag information; wherein one second zone corresponds to one space number, and the number of space numbers is equal to the number of second zones; one space number corresponds to one first zone; the flag information includes first information and second information; the first information indicates that the first zone is stored with data, and the second information indicates that the second zone is stored with data. When user data is written into the buffer area 105, the mapping table may be updated or generated, when data is migrated from the buffer area 105 to the storage area 107, the mapping table may be updated, the mapping table is to indicate the physical address in the data storage, and the mapping table may also include physical address information in the first zone corresponding to the space number, and physical address information in the second zone corresponding to the space number.

In some examples, the first zone includes multiple first subzones which include equal storage capacities and contiguous physical addresses, and the number of memory cells in the first subzone is equal to the number of memory cells in the second zone; a first one of first subzones in the first zones corresponds to one space number.

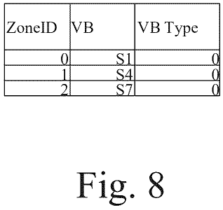

In some examples, as shown in FIG. 8, the space number in the mapping table may be the Zone ID of the zoned namespace, which corresponds to the second zone one by one, e.g., the space number Zone0 corresponds to the second zone T1, the space number Zone1 corresponds to the second zone T2, and Zone k-1 corresponds to the second zone Tk; when the processor 1063 divides the buffer area 105 and the storage area 107, the space number is generated and recorded according to the number of allocated second zones; VB corresponds to the first zone and is to indicate the physical address in the first zone, when the first zone includes multiple first subzones, a first one of first subzones of each first zone may be to represent the first zone to reduce the amount of data in the mapping table; the flag information is represented by VB Type, and one flag bit or one bit may be to indicate whether the data is stored in the first zone or the second zone, when VB Type is 0 (first information), it indicates that the data is in the first zone; when VB Type is 1 (second information), it indicates that the data is in the second zone. The logical address corresponds to the space number, e.g., Zone0 may correspond to the logical addresses LBA_1˜LBA_2000, Zone1 may correspond to LBA_2001˜LBA_4000, Zone2 may correspond to LBA_4001˜LBA_6000, Zone3 may correspond to LBA_6001˜LBA_8000, etc. Thus, the logical address is mapped to the Zone ID, the data corresponding to the Zone ID is stored in the first zone or the second zone, since the data is stored sequentially, the mapping table may store only the physical address corresponding to the first one of a range of logical addresses corresponding to the Zone ID, all logical addresses may be calculated, thereby reducing the amount of data in the mapping table. For example, if Zone 0 corresponds to LBA_1˜LBA_2000, the physical address may only record PBA_1 corresponding to Zone 0, and PBA_1 is the physical address of LBA_1 in the first zone or the second zone.

In some examples, the second zone and the first subzone may include physical memory blocks, the first subzone includes first memory blocks S1-S9, S1-S9 may represent or correspond to physical address information of multiple first memory blocks, and the first memory cell of the first memory block is configured as SLC; The second zone includes second memory blocks T1˜T6, T1˜T6 may represent or correspond to the physical address information of multiple second memory blocks, the second memory cell of the second memory block may be configured as TLC, and the number of memory cells in the first memory block is equal to the number of memory cells in the second memory block. Alternatively, the first subzone and the second zone may include physical pages, S1˜S9 may represent or correspond to the physical address information of multiple first physical pages, and T1˜T6 may represent or correspond to the physical address information of multiple second physical pages.

In some examples, as shown in FIG. 8, three second zones T1˜T3 are allocated, and Zone IDs (space number) 0˜2 is generated accordingly; the buffer area 105 includes first zones A1˜A3, and the three first zones include 9 first subzones S1˜S9 in total, the data corresponding to LBA_1 to LBA_6000 is written into the three first zones A1 to A3, VB records S1, S4 and S7 corresponding to space numbers 0, 1 and 2 respectively, at this point, the data has not been migrated to the second zone, and VB Type is the first information 0.

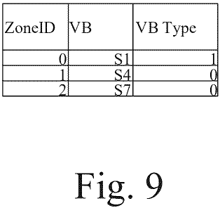

In some examples, as shown in FIG. 9, a portion of the data in the buffer area 105 is migrated to the storage area 107, and the mapping table is updated. The data in the first zone A1 (first subzones S1˜S3) corresponding to Zone ID 0 is migrated to the second zone T1, and the first zone A1 is erased, and the VB Type corresponding to Zone ID 0 is updated to the second information 1.

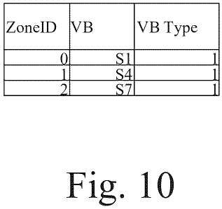

In some examples, as shown in FIG. 10, all the data in the buffer area 105 is migrated to the storage area 107, and the mapping table is updated. The data in the first zones A1˜A3 corresponding to Zone IDs 0˜2 is migrated to the second zones T1˜T3, and the first zones A1˜A3 are erased, and the VB Type corresponding to Zone IDs 0˜2 is updated to 1.

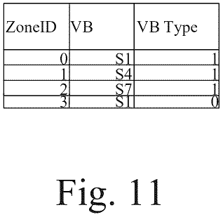

In some examples, as shown in FIG. 11, four second zones T1 to T4 are allocated, and Zone IDs 0 to 3 are generated accordingly, the data corresponding to LBA_1˜LBA_6000 corresponding to Zone IDs 0˜2 is written into the first zones A1˜A3 in sequence, and migrated to the second zones T1˜T3, the buffer space is released after the first zones A1˜A3 is erased, the VB Type corresponding to Zone IDs 0˜2 is updated to 1, the data corresponding to LBA_6001˜LBA_8000 is written into the first zone A1, and the VB Type corresponding to Zone ID 3 is updated to 0, at this point, the data in the first zone A1 has not yet been migrated to the second zone T4.

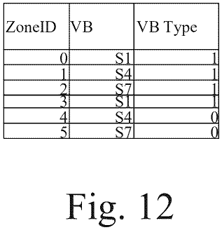

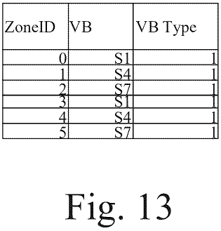

In some examples, as shown in FIG. 12, six second zones T1˜T6 are allocated, and Zone IDs 0˜5 are generated accordingly, the data corresponding to LBA_1˜LBA_6000 corresponding to Zone IDs 0˜2 is written into the first zones A1˜A3 in sequence, and migrated to the second zones T1˜T3, the VB Type corresponding to Zone IDs 0˜2 is updated to 1; the data corresponding to LBA_6001˜LBA_12000 corresponding to Zone IDs 3˜5 is written into the first zone A1˜A3, wherein the data of LBA_6001˜LBA_8000 in the first zone A1 is migrated to the second zone T4, and the VB Type corresponding to Zone ID 3 is updated to 1; the data corresponding to LBA_8001˜LBA_12000 is not migrated to the second zones T5 and T6, and the VB Type corresponding to Zone IDs 4˜5 is 0; in FIG. 13, after the data corresponding to LBA_8001˜LBA_12000 is migrated to the second zones T5 and T6, the VB Type corresponding to Zone IDs 4˜5 is updated to 1.

In the example of the present disclosure, in conjunction with the mapping tables shown in FIGS. 8 to 12, the Zone ID in the mapping table may correspond to the logical address, e.g., Zone0 may correspond to LBA_1˜LBA_2000, Zone1 may correspond to LBA_2001˜LBA_4000, Zone2 may correspond to LBA_4001˜LBA_6000, Zone3 may correspond to LBA_6001˜LBA_8000, etc. Zone ID corresponds to the second zone one by one, Zone k-1 corresponds to the second zone Tk, the number of Zone IDs is equal to the number of second zones, greater than or equal to the number of first zones, and greater than or equal to the number of first subzones; since data in the first zone of buffer area 105 will be migrated to the second zone of storage area 107 to release storage space, buffer area 105 may be frequently erased and written, and a first zone or first subzone may correspond to multiple Zone Ids, e.g., Zone IDs 0, 1, 2, 3, 4, and 5 correspond one-to-one to the second zones T1 to T6, respectively, and correspond to the first subzone S1 (first zone A1), the first subzone S4 (second zone A2), the first subzone S7 (second zone A3), the first subzone S1 (first zone A1), the first subzone S4 (second zone A2), and the first subzone S7 (second zone A3), respectively. The data corresponding to the logical address to which the Zone ID belongs may be stored in the first subzone (first zone) or the second zone, when VB Type is 1, it indicates that the data corresponding to the Zone ID is stored in the second zone corresponding to the Zone ID, while when VB Type is 0, it indicates that the data corresponding to the Zone ID is stored in the first zone corresponding to the Zone ID. For example, Zone0 may correspond to LBA_1˜LBA_2000, and the data corresponding to the logical address may be stored in the second zone T1 or the first zone A1, and when VB Type is 1, it indicates that the data is stored in the second zone T1, and the physical address in LBA_1 corresponding to the second zone T1 may be recorded in the mapping table; when VB Type is 0, it indicates that the data is stored in the first zone A1; the physical address in LBA_1 located in the first zone A1 may be recorded in the mapping table, and other addresses may be calculated based on sequential writing. For example, Zone3 may correspond to LBA_6001˜LBA_8000, and the data corresponding to the logical address may be stored in the second zone T4 or the first zone A1, when VB Type is 1, it indicates that the data is stored in the second zone T4, and when VB Type is 0, it indicates that the data is stored in the first zone A1. The present disclosure does not limit the number of Zone IDs, the number and capacities of the first zone and the second zone, and the processor 1063 may perform the division in combination with the vacant capacity of the memory device 104 and the current amount of data to be written to improve the write rate and reduce the write amplification.

In some examples, in conjunction with FIG. 6, the processor 1063 is further configured to: calculate the space number corresponding to the logical address according to the logical address corresponding to the data to be read; obtain the physical address corresponding to the logical address from the mapping table according to the space number and the flag information; and control the memory device 104 to read the data corresponding to the physical address.

Each space number (Zone ID) corresponds to each second zone one by one, each Zone ID corresponds to logical addresses of the same length, and the amount of data corresponding to each Zone ID is equal, e.g., a Zone ID corresponds to LBA_k˜LBA_(k+x−1), the logical address length of the data to be read is compared with the logical address length corresponding to a Zone ID, and the Zone ID corresponding to the logical address of the data to be read is calculated, the mapping table is looked up to get the VB Type value (flag information), it is confirmed that the data is stored in the first zone of the buffer area 105 or the second zone of the storage area 107 according to the flag information, and the physical address corresponding to the Zone ID is obtained; the physical address location at which the data is stored is sent to the memory device 104; the memory device 104 receives the physical address in the first zone and performs a reading according to the SLC read operation procedure; the memory device 104 receives the physical address in the second zone and performs a reading according to the read operation procedure for the TLC or other multi-level memory cells.

For example, Zone0 may correspond to LBA_1˜LBA_(k+x−1), Zone0 may correspond to LBA_1˜LBA_2000, the logical address length is 2000, Zone1 may correspond to LBA_2001˜LBA_4000, Zone2 may correspond to LBA_4001˜LBA_6000, Zone3 may correspond to LBA_6001˜LBA_8000, . . . , and so on; assuming that the logical addresses corresponding to the data to be read are LBA_1˜LBA_1500, it may be calculated that the logical address corresponds to Zone0; the physical address PBA_1 in the first zone or the second zone corresponding to Zone0 in the mapping table is obtained, PBA_1 corresponding to LBA_1, the entire physical addresses of LBA_1 to LBA_2000 are calculated to read the data. As another example, assuming that the logical addresses corresponding to the data to be read are LBA_1˜LBA_3500, it may be calculated that the logical address corresponds to Zone0 and Zone1; the physical address PBA_1 in the first zone or the second zone corresponding to Zone0 in the mapping table is obtained, PBA_1 corresponding to LBA_1; the physical address PBA_j in the first zone or the second zone corresponding to Zone1 in the mapping table is obtained, PBA_j corresponding to LBA_2001; the physical addresses corresponding to all of LBA_1 to LBA_3500 are calculated, and the data is read according to the physical addresses.

In some examples, referring to FIG. 6, the data buffer 1067 is configured to store a mapping table. In some examples, the data buffer 1067 is configured to: store data which is to be written into the buffer area 105; the processor 1063 is further configured to: write the data in the buffer area 105 into the buffer area 105.

The data to be written by the host 108 into the memory device 104 may be temporarily stored in the data buffer 1067, after the processor 1063 controls the memory device 104 generates or updates the mapping table shown in FIGS. 8 to 13 after writing data, the mapping table is stored in the data buffer 1067 or the RAM of the memory controller 106, or the DRAM of the memory system 102; the processor 1063, when performs a read operation, may access the data buffer 1067 to obtain the mapping table, and obtain the physical address corresponding to the logical address of the data to be read according to the mapping table, and send the physical address to the memory device 104; The memory device 104 reads the data at the corresponding physical address and feeds it back to the data buffer 1067 for buffer, and the processor 1063 feeds the read data temporarily stored in the data buffer 1067 back to the host 108. When the memory system 102 is powered off, the mapping table is stored in a storage area of the memory device 102.

According to some aspects of an example of the present disclosure, FIG. 1 and FIG. 6 illustrate a memory system, including: a memory controller 106 configured to send the first operation command; and a memory device 104 coupled to the memory controller 106; referring to FIG. 7, the memory device 104 includes: a buffer area 105 and a storage area 107; wherein the buffer area 105 includes multiple first zones which include contiguous physical addresses and equal storage capacities, the first zone includes multiple first memory cells in which data is stored in a single-level mode; the storage area 107 includes multiple second memory cells in which data is stored in a multi-level mode; the memory device 104 is configured to: in response to the first operation command, sequentially write data into the buffer area 105; and sequentially write data in the buffer area 105 into the storage area 107.

In some examples, the first operation command may be a write command, and the first operation command may include address information of a memory cell to which the data is to be written, or the address information may be sent to the memory device 104 along with the first operation command, the memory device 104 performs a program operation on the memory cell corresponding to the address in the buffer area 105 in response to the first operation command, the program operation may be an operation for the SLC memory cell. The first operation command may also indicate that when the buffer area 105 is fully written, the memory device 104 migrates the data in the buffer area 105 to the storage area 107 and erases the data in the buffer area 105 to release the buffer space. In some examples, when the buffer area 105 is fully written, the memory controller 106 sends a data migration operation command to the memory device 104, after receiving the data migration operation command, the memory device 104 migrates the data in the buffer area 105 to the storage area 107 and erases the buffer area 105 to release the buffer space; the data migration operation command may call the relevant data migration command in the garbage collection program of the memory controller 106 firmware to reduce the rewriting of the firmware program.

In some examples, the memory controller 106 is further configured to: configure multiple memory cells of the memory device 104 as the buffer area 105 and the storage area 107.

In some examples, the storage area 107 includes multiple second zones which include contiguous physical addresses and equal storage capacities; the storage capacity of each of the second zones is equal to the storage capacity of each of the first zones; the memory device 104 is further configured to: sequentially write data in the first zone into the second zone; and erase the data in the first zone that has been written into the second zone.

In some examples, the memory device 104 is further configured to: in response to the amount of data to be written to the memory device 104 being less than or equal to the storage capacity of the buffer area 105, write data into the buffer area 105; and write data in one first zone into one second zone, the written addresses in the second zone being contiguous.

In some examples, the memory device 104 is further configured to: in response to the amount of data to be written to the memory device 104 being greater than the storage capacity of the buffer area 105, write a portion of data into the buffer area 105; sequentially write data in the first zone into the second zone, and erase the first zone; wherein one first zone corresponds to one second zone; and write another portion of data into the erased first zone.

In some examples, the memory controller 106 is further configured to: generate a mapping table, the mapping table including a space number and flag information; wherein one second zone corresponds to one space number, and the number of space numbers is equal to the number of second zones; one space number corresponds to one first zone; the flag information includes first information and second information; the first information indicates that the first zone is stored with data, and the second information indicates that the second zone is stored with data.

In some examples, the first zone includes multiple first subzones which include equal storage capacities and contiguous physical addresses, and the number of memory cells in the first subzone is equal to the number of memory cells in the second zone; a first one of first subzones in the first zones corresponds to one space number.

In some examples, the memory controller 106 is further configured to: calculate the space number corresponding to the logical address according to the logical address corresponding to the data to be read; obtain the physical address corresponding to the logical address from the mapping table according to the space number and the flag information; and send the second operation command; the memory device 104 is configured to read data corresponding to the physical address in response to the second operation command. The second operation command may be a read command, and the second operation command may include address information of a memory cell to be read, or the address information may be sent to the memory device 104 along with the second operation command, the memory device 104 performs a read operation on the corresponding memory cell in the buffer area 105 or storage area 107 in response to the second operation command.

According to some aspects of the examples of the present disclosure, an electronic system is provided, the electronic system may include the system 100 shown in FIG. 1, including: a host 108 and a memory system 102; the memory system 102 including a memory device 104 and a memory controller 106 coupled to the memory device; in response to a first operation request from the host 108, the memory controller 106 is configured to: control the memory device 104 to sequentially write data into a buffer area 105 of the memory device 104; and sequentially write the data in the buffer area 105 into the storage area 107 of the memory device 104; wherein the buffer area 105 includes multiple first zones which include contiguous physical addresses and equal storage capacities, the first zone includes multiple first memory cells in which data is stored in a single-level mode; the storage area 107 includes multiple second memory cells in which data is stored in a multi-level mode. The buffer area 105 and the storage area 107 are shown in FIG. 7. The first operation request may be a write request sent by the host 108, and the memory controller 106 controls the memory device 104 to write data into the buffer area 105 or the storage area 107 in response to the first operation request. The host 108 may send the logical address corresponding to the data to be written and the corresponding data to be written to the memory controller 106, the memory controller 106 allocates a physical address for the logical address and controls the memory controller 106 to write, and after the write is successful, the logical address-physical address mapping table is updated.

In some examples, the memory controller 106 is configured to: in response to the first operation request, configure the multiple memory cells of the memory device 104 as the buffer area 105 and the storage area 107.

In some examples, the storage area 107 includes multiple second zones which include contiguous physical addresses and equal storage capacities; the storage capacity of each of the second zones is equal to the storage capacity of each of the first zones; the memory controller 106 is further configured to: control the memory device 104 to sequentially write data in the first zone into the second zone; and erase the data in the first zone that has been written into the second zone.

In some examples, the memory controller 106 is further configured to: in response to the amount of data to be written to the memory device 104 being less than or equal to the storage capacity of the buffer area 105, control the memory device 104 to write data into the buffer area 105; and control the memory device 104 to write data in one first zone into one second zone, the written addresses in the second zone being contiguous.

In some examples, the memory controller 106 is further configured to: in response to the amount of data to be written to the memory device 104 being greater than the storage capacity of the buffer area 105, writing a portion of data into the buffer area 105; control the memory device 104 to sequentially write data in the first zone into the second zone, and erase the first zone; wherein one first zone corresponds to one second zone; and write another portion of data into the erased first zone.

In some examples, the memory controller 106 is further configured to: generate a mapping table, the mapping table including a space number and flag information; wherein one second zone corresponds to one space number, and the number of space numbers is equal to the number of second zones; one space number corresponds to one first zone; the flag information includes first information and second information; the first information indicates that the first zone is stored with data, and the second information indicates that the second zone is stored with data.

In some examples, the first zone includes multiple first subzones which include equal storage capacities and contiguous physical addresses, and the number of memory cells in the first subzone is equal to the number of memory cells in the second zone; a first one of first subzones in the first zones corresponds to one space number.

In some examples, the memory controller 106 is configured to: in response to a second operation request from the host 108, calculate the space number corresponding to the logical address according to the logical address corresponding to the data to be read; obtain the physical address corresponding to the logical address from the mapping table according to the space number and the flag information; and control the memory device 104 to read the data corresponding to the physical address. The second operation request may be a read request. The host 108 may send the logical address corresponding to the data to be read to the memory controller 106, and the memory controller 106 accesses the logical address-physical address mapping table to send the physical address to be read to the memory controller 106, thereby controlling the memory controller 106 to read the data at the relevant address.

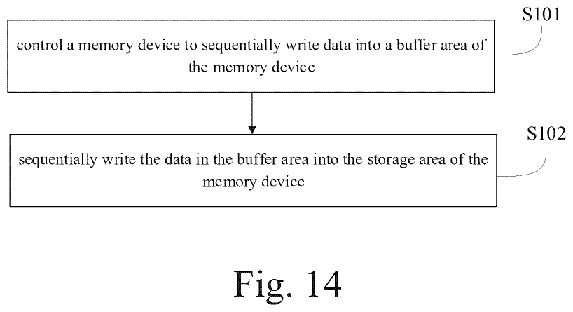

According to some aspects of the examples of the present disclosure, a method for controlling a memory controller 106 is provided in FIG. 14, including: controlling a memory device to sequentially write data into a buffer area of the memory device; and sequentially write the data in the buffer area into the storage area of the memory device; wherein the buffer area includes multiple first zones which include contiguous physical addresses and equal storage capacities, the first zone includes multiple first memory cells in which data is stored in a single-level mode; the storage area includes multiple second memory cells in which data is stored in a multi-level mode.

In some examples, the method further includes: configuring multiple memory cells of the memory device 104 as the buffer area 105 and the storage area 107.

In some examples, the storage area 107 includes multiple second zones which include contiguous physical addresses and equal storage capacities; the storage capacity of each of the second zones is equal to the storage capacity of each of the first zones; the method further includes: controlling the memory device 104 to sequentially write data in the first zone into the second zone; and erasing data in the first zone that has been written into the second zone.

In some examples, the method further includes: in response to the amount of data to be written to the memory device 104 being less than or equal to the storage capacity of the buffer area 105, controlling the memory device 104 to write data into the buffer area 105; controlling the memory device 104 to write data in one first zone into one second zone, the written addresses in the second zone being contiguous.

In some examples, the method further includes: in response to the amount of data to be written to the memory device 104 being greater than the storage capacity of the buffer area 105, writing a portion of data into the buffer area 105; controlling the memory device 104 to sequentially write data in the first zone into the second zone, and erasing the first zone; wherein one first zone corresponds to one second zone; writing another portion of data into the erased first zone.

In some examples, the method further includes: generating a mapping table, the mapping table including a space number and flag information; wherein one second zone corresponds to one space number, and the number of space numbers is equal to the number of second zones; one space number corresponds to one first zone; the flag information includes first information and second information; the first information indicates that the first zone is stored with data, and the second information indicates that the second zone is stored with data.

In some examples, the first zone includes multiple first subzones which include equal storage capacities and contiguous physical addresses, and the number of memory cells in the first subzone is equal to the number of memory cells in the second zone; a first one of first subzones in the first zones corresponds to one space number.

In some examples, the method further includes: calculating the space number corresponding to the logical address according to the logical address corresponding to the data to be read; obtaining the physical address corresponding to the logical address from the mapping table according to the space number and the flag information; and controlling the memory device 104 to read the data corresponding to the physical address.

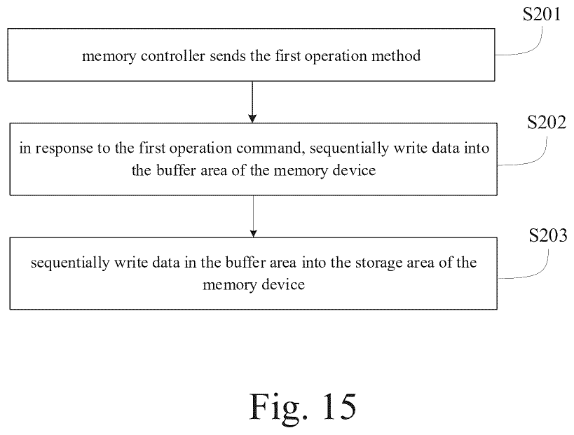

According to some aspects of the examples of the present disclosure, FIG. 15 provides a method for operating a memory system 102, including: sending, by a memory controller 106, a first operation command; in response to the first operation command, sequentially writing data into a buffer area 105 of a memory device 104; and sequentially writing the data in the buffer area 105 into the storage area 107 of the memory device 104; wherein the buffer area 105 includes multiple first zones which include contiguous physical addresses and equal storage capacities, the first zone includes multiple first memory cells in which data is stored in a single-level mode; the storage area 107 includes multiple second memory cells in which data is stored in a multi-level mode.

In some examples, the method further includes: configuring multiple memory cells of the memory device 104 as the buffer area 105 and the storage area 107.

In some examples, the storage area 107 includes multiple second zones which include contiguous physical addresses and equal storage capacities; the storage capacity of each of the second zones is equal to the storage capacity of each of the first zones; the method further includes: sequentially writing data in the first zone into the second zone; and erasing the data in the first zone that has been written into the second zone.

In some examples, the method further includes: in response to the amount of data to be written to the memory device 104 being less than or equal to the storage capacity of the buffer area 105, writing data into the buffer area 105; and writing data in one first zone into one second zone, the written addresses in the second zone being contiguous.

In some examples, the method further includes: in response to the amount of data to be written to the memory device 104 being greater than the storage capacity of the buffer area 105, writing a portion of data into the buffer area 105; sequentially writing data in the first zone into the second zone, and erasing the first zone; wherein one first zone corresponds to one second zone; writing another portion of data into the erased first zone.

In some examples, the method further includes: generating a mapping table, the mapping table including a space number and flag information; wherein one second zone corresponds to one space number, and the number of space numbers is equal to the number of second zones; one space number corresponds to one first zone; the flag information includes first information and second information; the first information indicates that the first zone is stored with data, and the second information indicates that the second zone is stored with data.

In some examples, the first zone includes multiple first subzones which include equal storage capacities and contiguous physical addresses, and the number of memory cells in the first subzone is equal to the number of memory cells in the second zone; a first one of first subzones in the first zones corresponds to one space number.

In some examples, the method further includes: calculating the space number corresponding to the logical address according to the logical address corresponding to the data to be read; obtaining the physical address corresponding to the logical address from the mapping table according to the space number and the flag information; sending, by the memory controller 106, a second operation command, and reading, by the memory device 104, data corresponding to the physical address in response to the second operation command.

According to some aspects of an example of the present disclosure, a readable storage medium is provided, the readable storage medium stores computer program that when executed, may implement a method for controlling a memory controller 106 and method for operating a memory system 102.

The memory device 104 may include a NAND memory, the memory cells of the NAND memory may be a “floating gate” type memory cell including a floating gate transistor, or a “charge trap” type memory cell including a charge trap transistor.

The storage medium may be memory such as Ferromagnetic Random Access Memory (FRAM), Read Only Memory (ROM), Programmable Read-Only Memory (PROM), Erasable Programmable Read-Only Memory (EPROM), Electrically Erasable Programmable Read-Only Memory (EEPROM), Flash Memory, Magnetic Surface Memory, Optical Disk, or Compact Disc Read-Only Memory (CD-ROM); or may also be various devices including one or any combination of the memory device 104 described above.

In some examples, executable instructions may take the form of a program, software, software module, script, or code, written in any form of programming language (including compiled or interpreted languages, or declarative or procedural languages), and may be deployed in any form, including as a stand-alone program or as a module, component, subroutine, or other unit suitable for use in a computing environment.

As an example, executable instructions may, but do not necessarily correspond to, files in a file system, and may be stored as part of a file holding other programs or data, e.g., one or more scripts stored in a HyperText Markup Language (HTML) document, stored in a single file for the program discussed, or stored in multiple collaborative files (e.g., a file that stores one or more modules, subroutines, or portions of code).

As examples, executable instructions may be deployed to execute on one electronic device, or on multiple electronic devices located at one location, or to execute on multiple electronic devices distributed across multiple locations and interconnected by a communications network.

The above is only an implementation of the present disclosure, but the claimed scope of the present disclosure is not limited thereto, and changes or substitutions within the technical scope disclosed in the present disclosure that may be easily conceived by those skilled in the art shall fall within the claimed scope of the present disclosure.

What is claimed is:

1. A memory controller, comprising
a data buffer; and
a processor coupled to the data buffer and configured to:
control a memory device to sequentially write data into a buffer area of the memory device; and
sequentially write the data in the buffer area into a storage area of the memory device;
wherein the buffer area includes multiple first zones which include contiguous physical addresses and equal storage capacities, the first zone includes multiple first memory cells in which data is stored in a single-level mode; the storage area includes multiple second memory cells in which data is stored in a multi-level mode.

2. The memory controller of claim 1, wherein the processor is further configured to:
configure multiple memory cells of the memory device as the buffer area and the storage area.

3. The memory controller of claim 1, wherein the storage area includes multiple second zones which include contiguous physical addresses and equal storage capacities; the storage capacity of each of the second zones is equal to the storage capacity of each of the first zones; the processor is further configured to:
control the memory device to sequentially write data in the first zone into the second zone; and
erase data in the first zone that has been written into the second zone.

4. The memory controller of claim 3, wherein the processor is further configured to:
in response to an amount of data to be written to the memory device being less than or equal to the storage capacity of the buffer area, control the memory device to write data into the buffer area; and
control the memory device to write data in one first zone into one second zone, the written addresses in the second zone being contiguous.

5. The memory controller of claim 3, wherein the processor is further configured to:
in response to an amount of data to be written to the memory device being greater than the storage capacity of the buffer area, write a portion of data into the buffer area;
control the memory device to sequentially write data in the first zone into the second zone, and erase the first zone; wherein one first zone corresponds to one second zone; and
control the memory device to write another portion of data into the erased first zone.

6. The memory controller of claim 3, wherein the processor is further configured to:
generate a mapping table, the mapping table including a space number and flag information;
wherein one second zone corresponds to one space number, and the number of space numbers is equal to the number of second zones, one space number corresponds to one first zone; and
the flag information includes first information and second information, the first information indicates that the first zone is stored with data, and the second information indicates that the second zone is stored with data.

7. The memory controller of claim 6, wherein the first zone includes multiple first subzones which include equal storage capacities and contiguous physical addresses, and the number of memory cells in the first subzone is equal to the number of memory cells in the second zone, a first one of first subzones in the first zones corresponds to one space number.

8. The memory controller of claim 6, wherein the processor is further configured to:
calculate a space number corresponding to a logical address according to the logical address corresponding to data to be read;
obtain a physical address corresponding to the logical address from the mapping table according to the space number and the flag information; and
control the memory device to read data corresponding to the physical address.

9. The memory controller of claim 6, wherein the data buffer is configured to store the mapping table.

10. The memory controller of claim 1, wherein
the data buffer is configured to: store data which is to be written into the buffer area; and
the processor is further configured to: write the data into the buffer area.

11. A memory system, comprising:
a memory controller configured to send a first operation command; and
a memory device coupled to the memory controller and comprising: a buffer area and a storage area; wherein the buffer area includes multiple first zones which include contiguous physical addresses and equal storage capacities, the first zone includes multiple first memory cells in which data is stored in a single-level mode; the storage area includes multiple second memory cells in which data is stored in a multi-level mode; the memory device is configured to:
in response to the first operation command, sequentially write data into the buffer area; and
sequentially write data in the buffer area into the storage area.

12. The memory system of claim 11, wherein the memory controller is further configured to:
configure multiple memory cells of the memory device as the buffer area and the storage area.

13. The memory system of claim 11, wherein, the storage area includes multiple second zones which include contiguous physical addresses and equal storage capacities; the storage capacity of each of the second zones is equal to the storage capacity of each of the first zones; the memory device is further configured to:
sequentially write data in the first zone into the second zone; and
erase the data in the first zone that has been written into the second zone.

14. The memory system of claim 13, wherein the memory controller is further configured to:
generate a mapping table, the mapping table including a space number and flag information;
wherein one second zone corresponds to one space number, and the number of space numbers is equal to the number of second zones, one space number corresponds to one first zone; and
the flag information includes first information and second information, the first information indicates that the first zone is stored with data, and the second information indicates that the second zone is stored with data.

15. The memory system of claim 14, wherein the first zone includes multiple first subzones which include equal storage capacities and contiguous physical addresses, and the number of memory cells in the first subzone is equal to the number of memory cells in the second zone, a first one of first subzones in the first zones corresponds to one space number.

16. The memory system of claim 14, wherein
the memory controller is further configured to:
calculate a space number corresponding to a logical address according to the logical address corresponding to data to be read;
obtain a physical address corresponding to the logical address from the mapping table according to the space number and the flag information; and
send a second operation command;
the memory device is configured to read data corresponding to the physical address in response to the second operation command.

17. A method for operating a memory system, comprising:
sending, by a memory controller, a first operation command;
in response to the first operation command, sequentially writing data into a buffer area of a memory device; and
sequentially writing data in the buffer area into a storage area of the memory device;
wherein the buffer area includes multiple first zones which include contiguous physical addresses and equal storage capacities, the first zone includes multiple first memory cells in which data is stored in a single-level mode, the storage area includes multiple second memory cells in which data is stored in a multi-level mode.

18. The method of claim 17, wherein, the storage area includes multiple second zones which include contiguous physical addresses and equal storage capacities, the storage capacity of each of the second zones is equal to the storage capacity of each of the first zones; the method further comprises:
sequentially writing data in the first zone into the second zone; and
erasing the data in the first zone that has been written into the second zone.

19. The method of claim 18, further comprises:
generating a mapping table, the mapping table including a space number and flag information;
wherein one second zone corresponds to one space number, and the number of space numbers is equal to the number of second zones, one space number corresponds to one first zone; and
the flag information includes first information and second information, the first information indicates that the first zone is stored with data, and the second information indicates that the second zone is stored with data.

20. The method of claim 19, wherein the first zone includes multiple first subzones which include equal storage capacities and contiguous physical addresses, and the number of memory cells in the first subzone is equal to the number of memory cells in the second zone;
a first one of first subzones in the first zones corresponds to one space number.
